(19) United States
(12) Patent Application Publication
(10) Pub. No.: US 2007/0249516 A1
(43) Pub. Date: Oct. 25, 2007

(54) RINSE-ADDED FABRIC TREATMENT COMPOSITION

(75) Inventors: Yun Peng ZHU, Fair Lawn, CT (US); Hong GU, Fair Lawn, NJ (US); Dennis Stephen MURPHY, Southbury, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER, Englewood Cliffs, NJ (US)

(21) Appl. No.: 11/379,245

(22) Filed: Apr. 19, 2006

(51) Int. Cl. C11D 3/00

(52) U.S. Cl. 510/521

(57) ABSTRACT

An aqueous rinse-added fabric treatment composition with improved anti-redeposition and fragrance delivery benefits. Methods of improving soil anti-redeposition, fragrance delivery and fabric treatment by rinsing the fabrics in a rinse solution comprising the inventive compositions.

### FIELD OF THE INVENTION

The invention relates to rinse-added fabric treatment compositions, which have fabric treatment and additional benefits, including anti-redeposition benefits, and to methods of using compositions and achieving various benefits from the use thereof.

### BACKGROUND OF THE INVENTION

Laundry detergents provide excellent soil removal, but can often make fabric feel harsh after washing. To combat this problem, a number of fabric conditioning technologies, if including rinse-added softeners, dryer sheets, and 2-in-1 detergent softeners, have been developed. The majority of fabric softeners contain a cationic active, which is deposited on the fabric. Rinse-added liquid fabric softeners are among the most popular forms of fabric softening products.

A consumer need exists for fabric softeners to deliver benefits in addition to fabric softening. The deposition of functional actives in the rinse cycle is higher than in wash cycle, and it is desirable to have a functional ingredient to deliver in the rinse cycle for benefits thereafter. One drawback of fabric softener treatment is a gradual excess accumulation of a cationic fabric softener on the surface of the fabric, especially after repeated use. The excess of cationic fabric softener on the fabric bears a positive charge and is hydrophobic, and tends to have a strong interaction with stain and soils that usually have a negative charge. This makes stains and soil more difficult to remove from fabrics and more easily re-deposited onto the fabric after being removed. Also, an excess build-up of conditioning agent on fabric might have a negative effect on anti-redeposition efficacy of detergent in the next wash. As the result, fabric, especially white fabric, looks dull after repeated treatment with a cationic fabric softener.

Therefore, there is a need to minimize the negative effect of fabric softener on anti-redeposition to keep fabric integrity.

Thus, there is a need to improve anti-redeposition in fabric softening treatment. Sodium carboxymethyl celluloses (hereinafter “CMC”) are known anti-redeposition agents. Unfortunately, due to their anionic nature, CMC interacts with cationic fabric actives in liquid formulations, resulting in instability and precipitation, thus detracting from the performance and appearance of the commercial product.

Various fabric treatment products containing fabric softening actives and CMC have been described. See for instance EP 257 861; WO 03/097781; Martens et al., US 2006/0030515; Ramachandran, U.S. Pat. No. 4,203,851; EP 885 283; EP 123 400.

The present invention is based at least in part on the discovery that liquid fabric treatment compositions may be manufactured which contain cationic fabric softeners and CMC (thus delivering fabric softening and additional benefits, including anti-redeposition), yet are physically stable.

### SUMMARY OF THE INVENTION

The present invention includes in part an aqueous rinse-added fabric treatment composition, the composition comprising:
(a) from about 2.5% to about 30%, by weight of the composition, of a cationic fabric softener, with the provision that when the cationic fabric softener has Formula (I) wherein each R¹ is methyl it is present in amount of at least about 10%;
(b) from about 0.0.5% to about 2%, by weight of the composition, of a water-soluble sodium carboxymethylcellulose having a molecular weight average from about 5,000 about 250,000 Da.

The invention also includes methods of improving anti-redeposition and fragrance delivery benefits of fabric treatment compositions.

### DETAILED DESCRIPTION OF THE INVENTION

Except in the operating and comparative examples, or where otherwise explicitly indicated, all numbers in this description indicating amounts of material or conditions of reaction, physical properties of materials and/or use are to be understood as modified by the word “about.” All amounts are by weight of the final liquid composition, unless otherwise specified.

It should be noted that in specifying any range of concentration, any particular upper concentration can be associated with any particular lower concentration.

For the avoidance of doubt the word “comprising” is intended to mean “including” but not necessarily “consisting of” or “composed of.” In other words, the listed steps or options need not be exhaustive.

“Liquid” as used herein means that a continuous phase or predominant part of the composition is liquid and that a composition is flowable at 15° C. and above (i.e., suspended solids may be included). Concentrated liquids and gels are included in the definition of liquid compositions as used herein.

Cationic Fabric Softeners

The fabric conditioning composition of the present invention comprises one or more cationic softening materials.

It is especially preferred if the cationic compound is a substantially water insoluble quaternary ammonium material which comprises a compound having two C₁₂₋₂₂ alkyl or alkenyl groups connected to the nitrogen head group via at least one ester link. It is more preferred if the quaternary ammonium material has two ester links present.

A first group of preferred cationic materials for use in the invention is represented by formula (I): 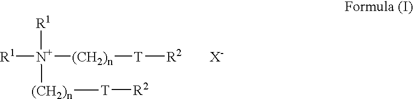
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups;

T is

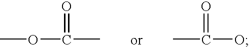

X⁻ is any anion compatible with the cationic surfactant, such as halides or alkyl sulphates, e.g. chloride, methyl sulphate or ethyl sulphate and n is 0 or an integer from 1-5.

Especially preferred materials within this formula are di-alkenyl esters of triethanol ammonium methyl sulphate and N-N-di(tallowoyloxy ethyl)N,N-dimethyl ammonium chloride. Commercial examples of compounds within this formula are Tetranyl AOT-1 (di-oleic ester of triethanol ammonium methyl sulphate 80% active), AO-1 (di-oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation); Rewoquat WE15 (C₁₀-C₂₀ and C₁₆-C₁₈ unsaturated fatty acid reaction products with triethanolamine dimethyl sulphate quaternised 90% active), ex Witco Corporation, Stepantex VK-90, Stepantex VQ-90, Stepantex PH90, StepanUL90 (Stepan); Armosoft TEQ-E and Armosoft HT-TEQ (Akzo Nobel); Varisoft WE18, Varisoft WE20 Varisoft WE HV, RewoquatWE20, Varisoft WE21CP (Degussa), and Armosoft DEQ (di-tallowylethyl ester dimethyl ammonium salt) from Akzo.

A second preferred type of quaternary ammonium material is represented by formula (II): 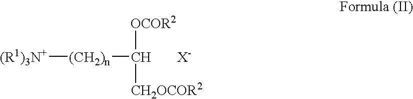
wherein R¹, R², n and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A third preferred type of quaternary ammonium material is represented by formula (III): 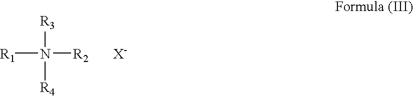
where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(hard tallow alkyl)dimethyl ammonium chloride, di(hard tallow alkyl)dimethyl ammonium methyl sulphate, di(tallow alkyl)dimethyl ammonium chlorides di(tallow alkyl)dimethyl ammonium methyl sulphate, dihexadecyl dimethyl ammonium chloride, dioctadecyl dimethyl ammonium chloride and di(coconut alkyl)dimethyl ammonium chloride. Commercially available sources of compounds within Formula III include Arquad2HT-75, Arquad HC, Arquad HTL8 MS (Akzo Nobel); Varisoft 137 (Degussa).

Another preferred cationic softening agent is diamido quaternary ammonium salt of formula (IV): 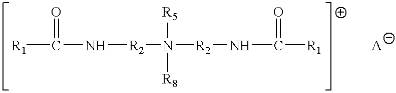
wherein R1 is an acyolic aliphatic C₁₅-C₂₂ hydrocarbon group, R₂ is a divalent alkylene group having 1 to 3 carbon atoms, R₅ and R₈ are C₁-C₄ saturated alkyl or hydroxyalkyl group and A is anion.

Also suitable are diamido alkoxylated quaternary ammonium salts having Formula (V): 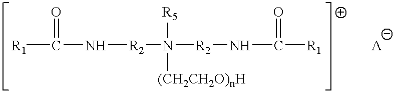
wherein n is equal to from about 1 to about 5, and R₁, R₂, R₅ and A are as defined above. Commercial sources of fabric softeners within Formula IV/Formula V include but are not limited to Stepan's Accosoft 460HC, Accosoft 501, Accosoft 550-L90, Accosoft 550-75, Accosoft 550-90 HHV, Accosoft 440-75; Dialkyl quat-90 (Rhodia); Varisoft 222LM90%, Varisoft 110, Rewoquat W222LM (Degussa), Incrosoft 100 pastilles (Croda).

Optionally, fatty acids may be used, as a coactive softening ingredient, to enhance deposition and to reduce cost. Suitably, fatty acids include those containing from about 12 to 25, preferably from about 13 to about 22, more preferably from about 16 to about 20, total carbon atoms, with the fatty chain having from about 10 to about 22, preferably from about 10 to 20, more preferably from about 12 to about 18 total carbon atoms. Fatty acids can have straight and branched saturated and unsaturated alkyl chains. Fatty acids are present in the product at a level of from 0% to about 5%, preferably from about 0.25% to about 2.5%.

It is advantageous for environmental reasons if the quaternary ammonium material is biologically degradable.

Generally, the cationic softeners are present in the composition in amount from 2.5%-30%, more preferably 5 to 27%, most preferably 5 to 25%.

If it is desired to provide the composition as a concentrate, then the cationic softeners are preferably present in an amount of 10-50%, more preferably 10-45% by weight, most preferably 10-30% by weight.

Preferred cationic compounds are substantially water insoluble.

CMC

The second essential ingredient is selected from specific group of CMC. By virtue of employing specific CMC, stability of liquid fabric softening compositions is maintained (i.e., no co-precipitation), without detriment to fabric softening, yet anti-redeposition and other favorable properties (enhanced fragrance deposition, improved shape retention) are attained.

In order to achieve these benefits, CMC included in the inventive compositions is selected from CMC with a molecular weight average in a range of from 15,000 to 250,000 Da (Daltons), more preferably in a range of from 20,000 to 90,000 Da. It has been found that CMC with the molecular weight average in the claimed ranges can be co-present with a cationic softener, despite the anionic nature of CMC without disturbing the physical stability of the composition, i.e. without causing precipitation and phase separation. The degree of substitution of CMC is also important: suitable CMC has a degree of substitution in the range of 0.5 to 1.5, preferably in the range of from 0.5 to 1. The most preferred CMC has a molecular weight of 90,000 and the degree of substitution of 0.7. The molecular weight is measured by use of size exclusion chromatography and is a weight average molecular weight. The degree of substitution (DS) describes the average number of carboxymethyl groups attached to each anhydroglucose unit. There are 3 hydroxyl groups per anhydroglucose unit on cellulose, and so the DS can range from 0 to 3. The DS of CMCs is determined by use of Near Infrared Adsorption Spectrum. In general, the DS can also be determined by the following method. Weigh accurately about 200 mg of the sample, previously dried at 105° to constant weight, and transfer it into a 250 ml, glass-stoppered Erlenmeyer flask. Add 75 ml of glacial acetic acid, and connect the flask with a water-cooled condenser, and reflux gently on a hot plate for 2 hours. Cool, transfer the solution to a 250-ml beaker with the aid of 50 ml of glacial acetic acid, and titrate with 0.1 N perchloric acid in dioxane while stirring with a magnetic stirrer. Determine the endpoint potentiometrically with a pH meter equipped with a standard glass electrode and a calomel electrode modified as follows: Discard the aqueous potassium chloride solution, rinse and fill with the supernatant liquid obtained by shaking thoroughly 2 g each of potassium chloride and silver chloride (or silver oxide) with 100 ml of methanol, then add a few crystals of potassium chloride and silver chloride (or silver oxide) to the electrode. Record the ml of 0.1 N perchloric acid versus mV (0 to 700 mV range), and continue the titration to a few ml beyond the endpoint. Plot the titration curve, and read the volume (A), in ml, of 0.1 N perchloric acid at the inflection point. Calculate the degree of substitution (DS) by the formula
(16.2 A/G)/[1.000−(8.0 A/G)],
where
A=the volume of 0.1 N perchloric acid required (ml)
G=weight of the sample taken (mg)
16.2=one-tenth of the formula weight of one anhydroglucose unit
8.0=one-tenth of the formula weight of one sodium carboxymethyl group

CMC is included in the inventive compositions in an amount of from 0.05 to 2%, preferably in an amount of from 0.3 to 2%, most preferably in an amount of from 0.5 to 2%. It has been found that relatively higher amounts of CMC within the included ranges produce soil anti-redeposition benefits after the first rinse, whereas lower (i.e. below 0.3%) amounts may need a repeated treatment with inventive compositions to deliver improved anti-redeposition benefits.

Water

The compositions are aqueous, that is, the inventive compositions comprise generally from 20% to 96.5%, preferably from 40% to 90% of water, most preferably from 50% to 80% to achieve optimum cost and ease of manufacturing, of water. Other liquid components, such as solvents, liquid organic matters including organic bases, and their mixtures can be present.

pH

The pH of the inventive liquid compositions is generally in the range of from 2.5 to 4.5. If the pH is too high, trace amounts of amine salts from fabric softener may precipitate, affecting product stability. Also, depending on the chemical properties of cationic softening agents, the pH affects the stability of the composition such as discoloration, degradation.

Process of Making Compositions

CMC is added slowly while stirring into water to get an even dispersion. The mixture then is heated to around 65° C. to ensure CMC is fully dissolved. To this solution at around 65° C., pre-melted cationic softening agent(s) is/are added slowly while maintaining mixing. A salt solution may be added at approximately halfway to the mixture through the addition of cationic softening agents as needed to avoid the formation of a gel or a thick dispersion. After the mixture is cooled down below 45° C., perfume and other ingredients may be added while keeping mixing. A salt solution may be added to the mixture to get the desirable viscosity. Also, the pH of the mixture is adjusted to pH 2.5 to 4.5 by use of inorganic or organic acid as needed.

Surfactant

Inventive compositions are preferably substantially free of detergent surfactant in order to maximize the performance from fabric softener. The cationic softeners included in the compositions interact unfavorably with anionic surfactants, thus detracting from the performance of the compositions. The presence of non-ionic and other surfactants is also preferably minimized since a surfactant removes compounds from the fabric, whereas the cationic softener and the CMC included in the inventive compositions seek to be deposited onto the fabric. Thus, the inventive compositions generally contain less than 2% of detergent surfactants, preferably less than 1%, most preferably less than 0.5% and optimally are entirely free of detergent surfactants.

Optional Ingredients

Suitable optional ingredients include but are not limited to optical brighteners, UV inhibitors, dye-transfer inhibitors, dye fixative, malodour reducer, bactericides, chelating agents, silicones as a cosoftener and chemicals conventionally used in textile treatment dispersion compositions for example, preservatives, anti-shrinkage agents, fabric crisping agents, antioxidants, perfumes and the like. Preferably, dye-transfer inhibitor, and optical brighter, cyclodextrin, and profragrance. Particularly, dye-transfer inhibitor, and optical brighter can be incorporated from 0.05% to 0.3%. Perfumes also are preferred, since the inventive compositions enhance perfume deposition.

Product Form

The composition is a liquid, preferably colored composition, packaged in the opaque plastic container.

The container of the present invention may be of any form or size suitable for storing and packaging liquids for household use. For example, the container may have any size but usually the container will have a maximal capacity of 0.05 to 15 L, preferably, 0.1 to 5 L, more preferably from 0.2 to 2.5 L. Preferably, the container is suitable for easy handling. For example the container may have handle or a part with such dimensions to allow easy lifting or carrying the container with one hand. The container preferably has a means suitable for pouring the liquid detergent composition and means for reclosing the container. The pouring means may be of any size of form but, preferably will be wide enough for convenient dosing the liquid detergent composition. The closing means may be of any form or size but usually will be screwed or clicked on the container to close the container. The closing means may be cap which can be detached from the container. Alternatively, the cap can still be attached to the container, whether the container is open or closed. The closing means may also be incorporated in the container.

Method of Using Compositions

The compositions are used for the rinsing of fabrics, preferably in the rinse cycle of the automatic washing machine. In use, the indicated quantity of the composition (generally in the range from 30 to 200 ml or 30 g to 200 grams) depending on the actives of the composition depending on the size of the laundry load, the size and type of the washing machine, is added to the washing machine which also contains water and the soiled laundry.

Benefits

The compositions of this invention are intended to confer conditioning benefits to garments, home textiles, carpets and other fibrous or fiber-derived articles. These formulations are not to be limited to conditioning benefits, however, and will often be multi-functional.

The primary treatment benefit afforded by these products is softening. Softening includes, but is not limited to, an improvement in the handling of a garment treated with the compositions of this invention relative to that of an article laundered under identical conditions but without the use of this invention. Consumers will often describe an article that is softened as “silky” or “fluffy”, and generally prefer the feel of treated garments to those that are unsoftened.

The conditioning benefits of these compositions are not limited to softening, however. They may, depending on the particular embodiment of the invention selected, also provide an antistatic benefit. In addition to softening, the inclusion of CMC into the inventive compositions is believed to provide anti-redeposition benefits, enhanced fragrance deposition and enhanced shape-retention benefit.

The following specific examples further illustrate the inventions but the invention is not limited thereto.

Armosoft DEQ—a cationic softening agent from Akzo Nobel.

The sodium carboxymethylcelluloses (CMC) are from Aqualon.

Ambergum 3021—a sodium carboxymethylcellulose with a molecular weight average of approximately 15,000 and an average degree of substitution (DS) of about 1.3.

CMC-T 7LT is a technical grade sodium carboxymethylcellulose with a molecular weight average of 90,000 Da with a DS of 0.7.

CMC-7L2 has a DS of 0.84 with a molecular weight average of about 90,000 Da.

CMC-7H4XF is a sodium carboxymethylcellulose with a molecular weight average around 700,000 with an average DS of 0.7.

### EXAMPLES

These examples investigated the compatibility of various fabric softening actives with various CMC. The compositions were prepared by a method described above under Process of Making Compositions. The compositions that were prepared and the results that were obtained are summarized in Tables 1-8 below.

The actives of the ingredients listed are 100% as it is.

TABLE 1

| | 1 | 2 | 3 | 4 | 5 | 6 | A | B | C |
|---|---|---|---|---|---|---|---|---|---|
| Ingredients | weight % | | | | | | | | |
| Lactic acid | 0.15 | 0.15 | 0.15 | 0.15 | 0.15 | 0.15 | | | 0.15 |
| Ambergum3021 | 0.13 | 0.13 | 0.13 | | | | | 0.13 | |
| CMC-T 7LT | | | | 0.13 | 0.13 | 0.13 | 0.13 | | |
| CMC-7H4xF | | | | | | | | | 0.13 |
| Armosoft DEQ | 10.00 | 21.0 | 17.0 | 17.0 | 17.0 | 10 | 5.5 | 5.5 | 10 |
| Fragrance | qs | qs | qs | qs | qs | qs | qs | qs | qs |
| Presevative | qs | qs | qs | qs | qs | qs | qs | qs | qs |
| AlK(SO4)2•12H2O | 0.05 | | 0.13 | 0.16 | | 0.06 | 0.01 | 0.01 | 0.02 |
| CaCl2•2H20 | 0.0 | 0.13 | | | 0.13 | | | | |
| Water | to 100% | to 100% | to 100% | to 100% | to 100% | to 100% | to 100% | to 100% | to 100% |
| Stability, overnight | good | good | good | good | good | good | phase | phase | phase |
| | | | | | | | separation | separation | separation |
| Stability, 1 month | good | good | good | good | good | good | N/A | N/A | N/A |

TABLE 2

| | 7 | 8 | 9 | 10 | 11 |
|---|---|---|---|---|---|
| Ingredients | weight % | | | | |
| Lactic acid | | 0.10 | 0.10 | | |
| Ambergum3021 | 0.13 | | | 0.13 | |
| CMC-T 7LT | | 0.80 | | | 0.13 |
| CMC-7L2 | | | 0.80 | | |
| Armosoft DEQ | | 17.0 | 17.0 | | |
| Ditallow dimethyl | 5.5 | | | 9.5 | 9.5 |
| ammonium chloride | | | | | |
| methyl | | | | 6.0 | 6.0 |
| bis(tallowamidoethyl)- | | | | | |
| 2-hydroxyethyl ammonium | | | | | |
| methyl sulfate | | | | | |
| dye | qs | qs | qs | qs | qs |
| Fragrance | qs | qs | qs | qs | qs |
| Preservative | qs | qs | qs | qs | qs |
| AlK(SO4)2•12H2O | | | | 0.13 | |
| CaCl2•2H20 | 0.001 | 0.12 | 0.13 | | 0.15 |
| Water | to | to | to | to | to |
| | 100% | 100% | 100% | 100% | 100% |
| Stability, overnight | good | good | good | good | good |
| Stability, 1 month | good | good | good | good | good |

TABLE 3
Fabric softening evaluation

| | D | 12 | 13 | 14 | E |
|---|---|---|---|---|---|
| Ingredients | weight % | | | weight % | |
| Lactic acid | 0.15 | 0.15 | 0.15 | | |
| Ambergum3021 | | 0.13 | | 0.13 | |
| CMC-T 7LT | | | 0.13 | | |
| CMC-7H4xF | | | | | |
| ArmosoftDEQ | 19.0 | 17.0 | 17.0 | | |
| Ditallowdimethyl | | | | 5.5 | 5.5 |
| ammonium chloride | | | | | |
| dye | qs | qs | qs | qs | qs |
| Fragrance | qs | qs | qs | qs | qs |
| Presevative | qs | qs | qs | qs | qs |
| AlK(SO4)2•12H2O | | 0.13 | | | |
| CaCl2•2H20 | 0.13 | | 0.13 | 0.001 | 0.006 |
| Water | to 100% | to 100% | to 100% | to 1.00% | to 100% |
| Dosage (g) | 26.5 | 29.6 | 29.6 | 72.0 | 72.0 |
| Active (g) | 5.04 | 5.03 | 5.03 | 3.96 | 3.96 |
| Softening score | 3.25 | 4.04 | 3.00 | 5.83 | 6.17 |

Compositions D and F were used as control in evaluation of softening performance. Both D and E did not contain CMC. A multiple comparison method was used to evaluate the softening performance. The dosages and actives are listed in Table 3 above. Composition were added in the rinse-cycle at the amount of dosage. A total 2.7 kg of fabrics including 2 harshened towels were washed with 98.6 g of Tide® original scent detergent in 82.3 liters of water at 120 ppm hardness. At the rinse cycle, a certain amount of fabric softener was added, and the water hardness was adjusted. After rinse cycle, the fabrics were tumble dried. Next day, the towels were evaluated by panelists. A duplicate test with different wash machines and dryer was carried out. When compositions D, 12 and 13 were evaluated, twenty-eight observation of towel softness were made for each composition. When compositions 14 and E were evaluated, twenty-four observation of towel softness were made for each composition. The softness was scored from 1 to 10, 1 was the least soft and 10 was the most soft. The score was an average of scores from the observation. It can be seen that all tested compositions delivered softening benefit, i.e. the addition of CMC did not deleteriously affect the softening benefit.

The compositions in Table 4 below were used in examination of softening performance of the composition having CMC against composition D without CMC. Thirty-six observation of towel softness were made for each composition. It can be seen again that the addition of CMC did not detract from softening performance.

TABLE 4
Softening Evaluation

| | D | 15 | 16 |
|---|---|---|---|
| Ingredients | weight % | | |
| Water | to 100% | to 100% | to 100% |
| Lactic acid | 0.15 | 0.10 | 0.10 |
| Ambergum3021 | | | |
| CMC-T 7LT | | 0.80 | |
| CMC-7L2 | | | 0.8 |
| ArmosoftDEQ | 19.0 | 17.0 | 57.0 |
| dye | qs | qs | qs |
| Fragrance | qs | qs | qs |
| Presevative | qs | qs | qs |
| AlK(SO4)2•12H2O | | 0.13 | |
| CaCl2•2H20 | 0.13 | | 0.13 |
| Dosage (g) | 26.5 | 29.6 | 29.6 |
| Active (g) | 5.04 | 5.03 | 5.03 |
| Softening score | 5.61 | 6.08 | 5.64 |

Antiredeposition Test

The antiredeposition performance of compositions D, 4, 15, and 16 was evaluated. A Terg-O-Tometer was used to examine the anti-redeposition property. Fabric was first treated with each composition having the same actives in one liter of water with water hardness adjusted to 120 ppm. After drying, two pieces of the treated fabrics were washed by use of “all free clear detergent”® in Terg-O-Tometer in the presence of stain-clothes and soil in 1 liter water with hardness of 120 ppm. After drying, the fabrics were read with a Hunter UltraScan Prospectrophotometer. The used stain-cloth and soil were EMPA106, a particulate oil stain and a carbon black or a dispersion of carbon black, a particulate soil.

Cotton Fabrics (4×6 inches) were used. TIC429 is weaved and TIC460 is double-knitted cotton. Six pieces of TIC429 were treated in each pot and four pieces of TIC460 were treated in each pot by adding the fabrics to 1000 ml of 0.050% of a tested softening (as it is 100%). The water hardness was adjusted to 120 ppm hardness. The bath was agitated at 100 rpm at 24° C. for 12 min. The fabrics were taken out from the fabric softener solution and squeezed to remove the extra water. The fabric softener-treated fabrics were then dried.

In antiredeposition test two fabric softener-treated fabrics were added to 1000 ml of a 0.17% all free clear detergent aqueous solution with donor stain-clothes and soils. The water hardness was adjusted to 120 ppm hardness. The wash bath was agitated at 100 rpm at 32° C. for 12 min. along with stain-donors clothes. The washed fabrics were taken out from the detergent solution. After rinsed in running water, the fabric were dried and then read by use of Hunter UltraScan Prospectrophotometer to evaluate the antiredeposition effect.

The TIC429 fabrics were treated with the fabric softener and washed with “all free clear”® twice in the presence of 0.05 g carbon black in one liter of 0.17% “all free clear”® detergent solution. L* is the lightness of fabric and dE is the difference in color against the original standard fabric. The smaller the dE, the less color change the fabric has after wash, indicating better antiredeposition. The results are in Table below. The fabric treated with composition 4 having 0.13% CMC T7LT gave better whiteness than composing D having no CMC.

TABLE 5
Antiredeposition of particulate soils

| Sample | L* | dE |
|---|---|---|
| D | 71.71 | 15.91 |
| 4 | 73.04 | 14.58 |

The TIC460 fabrics were treated with the fabric softener and washed with “all free clear”® one time with 25 g of 0.2% carbon black dispersion in one liter of 0.17% “all free clear”® detergent solution. The fabric treated with Composition 15 having 0.8% CMC-T 7LT gave better whiteness than Composition D having no CMC (see Table 6). Actually, it was easy to visually notice the difference between the two fabrics.

TABLE 6
Antiredeposition of particulate soils

| Sample | L* | dE |
|---|---|---|
| D | 76.02 | 16.24 |
| 15 | 79.43 | 12.82 |

The TIC460 fabric was treated with the fabric softener and washed with “all free clear”® with 3 pieces of EMPA106 as a stain donor-cloth and 25 g of 0.2% carbon black dispersion in 1000 ml of 0.17% “all free clear”® detergent aqueous solution. The fabric treated with compositions 15 and 16 that had 0.8% CMC gave better whiteness than composition D without CMC. Actually, it was easy to visually notice the difference among the three fabrics. The fabric treated with Composition 15 with CMC T 7LT was slightly whiter than the fabrics treated with Composition 16 with CMC 7L2, and both of them were much whiter than the fabrics treated by with Composition D having no CMC.

TABLE 7
Antiredeposition of mixed soils of particulate
soils and oil particulate soil

| Sample | L* | dE |
|---|---|---|
| D | 74.91 | 17.19 |
| 15 | 78.92 | 13.20 |
| 16 | 77.23 | 14.89 |

The TIC460 fabric was treated with the fabric softener and washed with “all free clear”® with 3 pieces of EMPA106 as a stain donor-cloth in 1000 ml of 0.17% “all free clear”® detergent aqueous solution. The fabric treated with Compositions 15 and 16 that have 0.8% CMC gave better whiteness than Composition D without CMC.

TABLE 8
Antiredeposition of oil particulate soils

| Sample | L* | dE |
|---|---|---|
| D | 87.51 | 4.45 |
| 15 | 88.62 | 3.37 |
| 16 | 88.29 | 3.70 |

1. An aqueous rinse-added fabric treatment composition, the composition comprising:
(a) from about 2.5% to about 30%, by weight of the composition, of a cationic fabric softener, with the provision that when the cationic fabric softener has Formula (I) 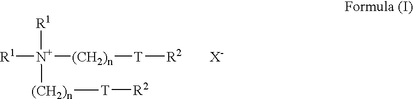
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups;
T is 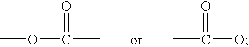
X⁻ is any anion compatible with the cationic surfactant, such as halides or alkyl sulphates, e.g. chloride, methyl sulphate or ethyl sulphate and n is 0 or an integer from 1-5 and when each R¹ is methyl group, it is present in amount of at least about 10%;
(b) from about 0.05% to about 2%, by weight of the composition, of a water-soluble sodium carboxymethylcellulose having a molecular weight average from about 5,000 about 250,000 Da and having a degree of substitution of from about 0.5 to about 1.5.

2. The composition of claim 1, wherein the composition comprises less than 2% detergent surfactants selected from the group consisting of anionic and nonionic surfactants.

3. (canceled)

4. The composition of claim 1, wherein the pH of the composition is in the range of from about 2.5 to about 4.5.

5. The composition of claim 1 further comprising a fatty acid.

6. The composition of claim 1, wherein the carboxymethyl cellulose is present in an amount of at least about 0.3% by weight of the composition.

7. The composition of claim 1 wherein the composition is in the form of a stable dispersion.

8. The composition of claim 7 wherein the composition is stable for at least a year at room temperature.

9. The composition of claim 1 wherein the molecular weight average of the carboxymethyl cellulose is below about 100,000 Da.

10. The composition of claim 9 wherein the molecular weight average of the carboxymethyl cellulose is from about 10,000 to about 90,000 Da.

11. The composition of claim 1 wherein the carboxymethyl cellulose has a molecular weight average of about 90,000 Da and the degree of substitution of about 0.7.

12. The composition of claim 1 wherein the composition further comprises an ingredient selected from the group consisting of optical brighters, dye transfer inhibitors, cyclodextrins, profragrances, silicones, dye-fixativess, UV absorbers, and mixtures thereof.

13. A method of soil anti-redeposition during laundering of fabrics, the method comprising rinsing the fabrics with a rinse solution comprising the composition of claim 1.

14. A method of delivering fabric treatment benefits to fabrics by rinsing the fabrics with a rinse solution comprising the composition of claim 1.

15. A method of improving the fragrance deposition onto the fabrics, the method comprising rinsing the fabrics with a rinse solution comprising the composition of claim 1.
